(19) United States
(12) Patent Application Publication
(10) Pub. No.: US 2003/0115469 A1
(43) Pub. Date: Jun. 19, 2003

(54) Systems and methods for detecting and deterring rollback attacks

(75) Inventors: Keith L. Shippy, Tempe, AZ (US); Richard P. Mangold, Forest Grove, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/017,055

(22) Filed: Dec. 14, 2001

(51) Int. Cl. H04L 9/00

(52) U.S. Cl. 713/178; 380/232; 705/52

(57) ABSTRACT

A log of access to protected content is kept that has forced periodic updates, even if no access has occurred. Systems and methods make it difficult to determine when the access log will be modified next. A server securely sends a variable time period (VTP) and a time duration to the next connection (TDNC) to a client. These two values determine how often the client must update the access log and how long the client must wait before establishing communication with the server. Thus, the server is able to detect and deter rollback attacks.

### BACKGROUND

A rollback attack occurs when a user makes a copy of an access log, gains wrongful access, and then copies the old access log back again to conceal his access. Suppose the user must pay a fee after a number of accesses to media content, such as music, videos, digital versatile discs (DVDs), and games, but cheats a content provider out of a payment with a rollback attack. When the user remains connected to the server, rollback attacks are less of a problem. But, when the user only periodically connects to the server, a record or access log must be maintained to track the number and type of accesses for billing purposes and this access log is more susceptible to rollback attacks. Rollback attacks and other access log tampering must be detected and deterred to stop theft of media content.

### BRIEF DESCRIPTION OF THE DRAWINGS

FIG. 1 is a block diagram of an example access log.

FIG. 2 is a block diagram of an example client-server architecture for practicing the present invention.

FIG. 3 is a block diagram of an embodiment of the present invention as a system for detecting and deterring rollback attacks.

FIG. 4 is a block diagram of client-server communication for an embodiment of the present invention as a method for detecting and deterring rollback attacks.

FIG. 5 is a flow chart of an embodiment of the present invention as a method for detecting and deterring rollback attacks.

FIG. 6 is a block diagram of an embodiment of the present invention as a machine for detecting and deterring rollback attacks.

FIG. 7 is a block diagram of client-server communication for an embodiment of the present invention as a method for detecting and deterring rollback attacks.

### DETAILED DESCRIPTION

Systems and methods for detecting and deterring rollback attacks are described. In the following detailed description, reference is made to the accompanying drawings, which are part of this application. These drawings illustrate specific embodiments for practicing the present invention and reference numbers refer to substantially similar components throughout the drawings. The embodiments are described in sufficient detail to enable those skilled in the art to practice the present invention. Other embodiments may be used and structural, logical, electrical, and other changes may be made without departing from the scope of the present invention.

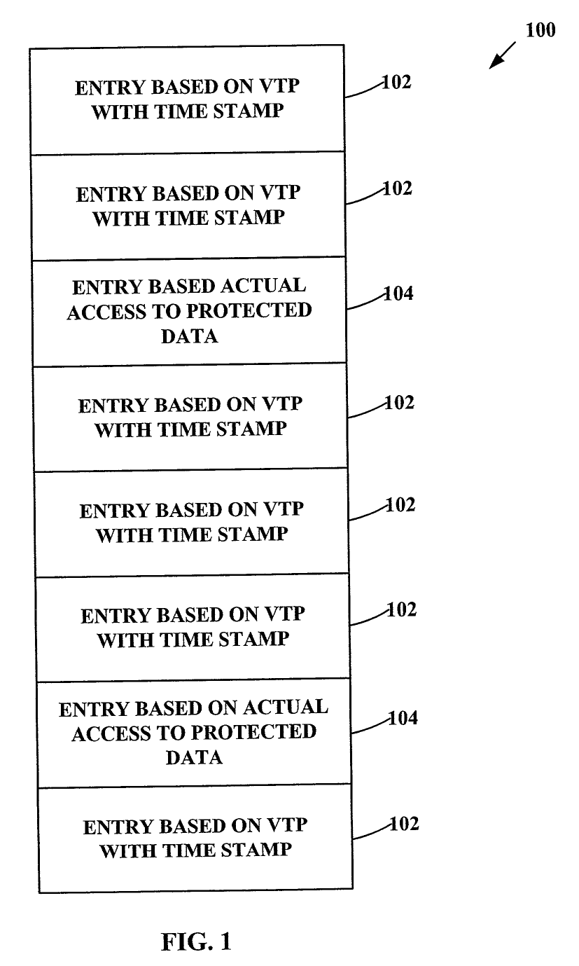

FIG. 1 is a block diagram of an example access log 100. An access log 100 is a file or other permanent or semi-permanent data stored in memory. The present invention (1) forces periodic updates to an access log 100, even if no access has occurred and (2) makes it difficult for an attacker to determine when the access log 100 will be modified. The present invention makes it difficult to determine when the access log 100 will be modified because a server transmits two values to a client each time they connect to exchange information. The client uses these two values to determine how often to update the access log and how long to wait until the next time to establish communication with the server. The access log 100 in FIG. 1 has two types of entries: forced entries 102 and entries based on user access to content 104. Content is any kind of protected data, such as music, videos, and games. Example entries include data such as date, time, type of entry, an identifier indicating what content was accessed, billing information, and any other information to help detect and deter rollback attacks. Forced entries 102 are created each variable time period (VTP), while entries based on user access 104 are created before, during, or after the user accesses protected data. The variable time period (VTP) is a piece of data representing a time period that is chosen by a server and transmitted to a client. Then, the client uses the variable time period (VTP) to determine how often to update the access log 100. Suppose the variable time period (VTP) is 24 hours and the time duration to the next connection (TDNC) is 6 days. The time duration to the next connection (TDNC) is data representing any period of time. The client accesses protected data twice 104, as shown in FIG. 1. The client waits for 6 days before establishing contact with the server, and each day a forced entry 102 is made, as shown in FIG. 1. Once the client sends the access log 100 back to the server, the server verifies the entries in the access log 100 to ensure they are correct using the variable time period (VTP) and the time duration to the next connection (TDNC) that the server sent to the client 6 days earlier.

In one embodiment, the secrecy of the VTD and TDNC values are further protected, while they are being used by the client. The VTD and TDNC values are further protected from tampering or from unauthorized access by the use of a number of anti-tampering techniques such as, for example, self-modification of software running on the client, the use of anti-debugging techniques, self-verification of software running on the client, signature verification of software running on the client, and other applicable anti-tampering techniques. The use of these anti-tampering techniques prevents unauthorized access or modification of software running on the client, which prevents the unauthorized access or modification of the VTD and TDNC as they are being used by the client.

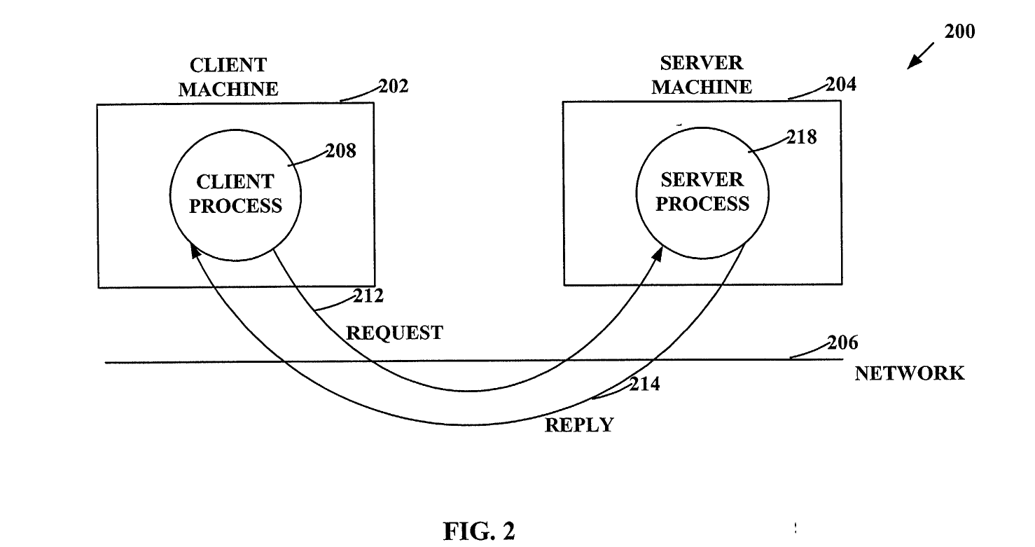

FIG. 2 is a block diagram of an example client-server architecture 200 for practicing the present invention. The client machine 202 and server machine 204 are any type of computing devices capable of communicating over a network 206, such as a local area network (LAN), or the Internet. The client machine 202 includes a client process 208 and the server machine 204 includes a server process 210. Suppose the client process 208 sends a request 212 to connect to the server process 210. The server process 210 replies 214 establishing a connection over the network 206. One example of a connection is a secure authenticated channel (SAC). The present invention applies to any client-server based content delivery system where the client accesses content in a controlled environment. Any multimedia content protection system, like secure music delivery or video over the Internet may use the present invention to detect and deter rollback attacks and other suspicious activity.

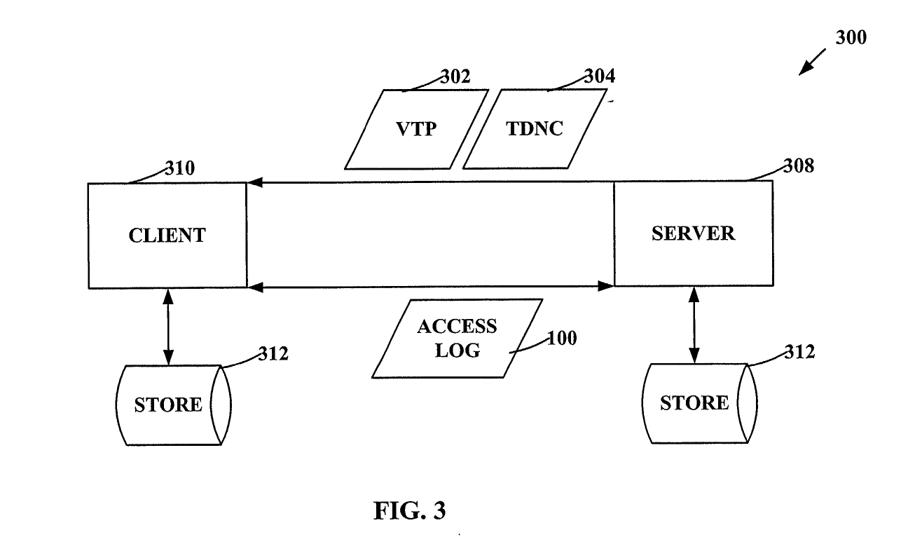

FIG. 3 is a block diagram of an embodiment of the present invention as a system 300 for detecting and deterring rollback attacks. One aspect of the present invention is a system, such as a system for detecting and deterring rollback attacks 300. The system comprises a variable time period (VTP) 302, a time duration to a next connection (TDNC) 304, an access log 100, a server 308, and a client 310. The client 310 and server 308 have access to memory or other storage mediums 312, such as a hard drive or floppy disk. For example, the client 310 may store the access log 100 once it is received from the server 308. The server 308 transmits the variable time period (VTP) 302 and the time duration to the next connection (TDNC) 304 to the client 310 and verifies the access log 100. The client 310 updates the access log 100 approximately every variable time period (VTP) 302 and connects to the server 308 approximately after the time duration to the next connection (TDNC) 304.

For example, suppose the client 310 periodically checks to see if the specified time duration in the variable time period (VTP) 302 has occurred. If so, the client 310 adds an entry to the access log 100 and increments a count of the entries in the access log 100. If the count of the entries is less than the time duration to the next connection (TDNC) 304, then normal operation resumes. Otherwise, if the count of entries is greater than or equal to the time duration to the next connection (TDNC) 304, then it is time for the client 310 to reconnect to the server 308 and send the updated copy of the access log 100.

When the server 308 receives the access log 100, the entries are verified. For example, the server makes sure that the number of entries and the differences in time between the entries is correct for the variable time period (VTP) 302 and the time duration to the next connection (TDNC) 304 values that were sent to the client 310 during the previous exchange. If not, then the server rejects the connection and decides not to send protected data to that client 310 anymore. This makes it difficult to mount a rollback attack on the access log 100, because when an attacker does a rollback, the entry count is never incremented and the client 310 never initiates a new exchange with the server 308. No new exchange denies the attacker access to new content. In addition, it is difficult for the attacker to automate a rollback attack because any software attempting to do the rollback will not know when to do the rollback without disturbing the expected entries in the access log 100.

The present invention also reduces the window of opportunity for an attacker to mount a rollback attack, because the server 308 has an opportunity to force more frequent secure authenticated channel (SAC) exchanges with suspicious clients 310. If a client 310 is suspected of foul play, then the server 308 can make the time duration to the next connection (TDNC) 304 small so that the client 310 must initiate exchanges with the server 308 more frequently (e.g. every 1.5 hours). In addition, the server 308 can make the variable time period (VTP) small, such as 15 minutes so that the client 310 must update the access log more frequently. Then, when a user tries to rollback he has only a 15-minute window. This makes it more difficult, especially since the user would not know the window was only 15 minutes.

While rollback attacks may still be possible when practicing the present invention, they are more difficult to do and more difficult to automate. For example, an automated software tool running as a background process to perform rollback attacks fails on a system incorporating the present invention, because the time to connect and periodic updates occur at unknown times. Also, the access log is constantly changing. This forces the attacker to do the rollback manually, which reduces the number of users willing to mount a rollback attack. In summary, the present invention deters rollback attacks and provides a mechanism to detect and react when a rollback attack occurs.

In one embodiment, the client 310 is a personal computer (PC). On a PC, hiding information is more difficult, because its architecture is usually well known and standard operating systems make it difficult to ensure security simply by hiding information. Therefore, making a rollback attack burdensome with the present invention is more effective. An attacker must constantly be monitoring when entries are added and generally go to a lot more effort. At some point, it is not worth it to the attacker and he is deterred. In another embodiment, the client 310 is a set-top box. For example, a set top box without floppy drives and no easy way for an attacker to log in. Another example is a cable box having 15 to 20 movies cached on a hard drive in an encrypted format that a user can select from at any time. Information about the movies watched is transferred at a later time to a server 308 for billing purposes.

In another embodiment, the server 308 is a video home server. In another embodiment, the server 308 is a pay-per-view video server. In another embodiment, the server 308 is a video-on-demand server. In another embodiment, the server 308 is a media content provider. In another embodiment, the next connection is a Secure Authenticated Channel (SAC). In another embodiment, the access log 100 is used for billing.

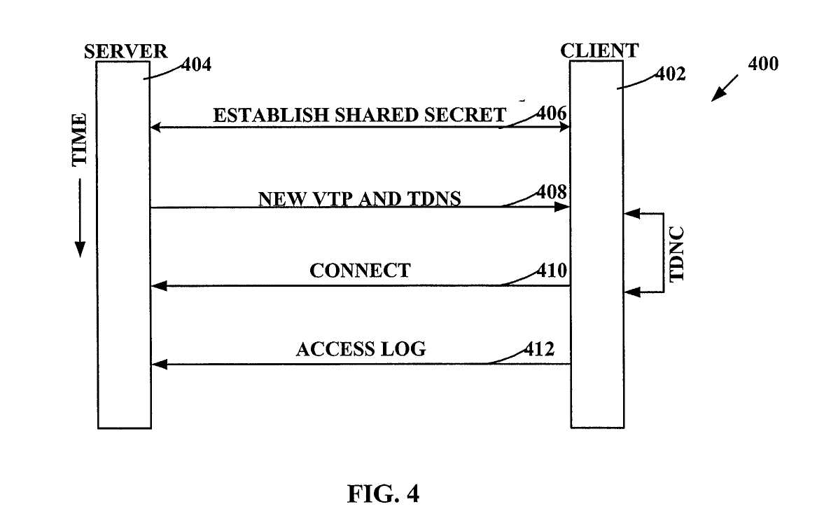

FIG. 4 is a block diagram of client-server communication for an embodiment of the present invention as a method for detecting and deterring rollback attacks. The client 402 and server 404 establish a shared secret 406. Then, the server 404 transmits 408 a new variable time period (VTP) and a new time duration to the next connection (TDNC) to the client 402. After the new time duration to the next connection (TDNC) expires, the client 402 connects 410 to the server 404 and transmits the access log 412 to the server 404.

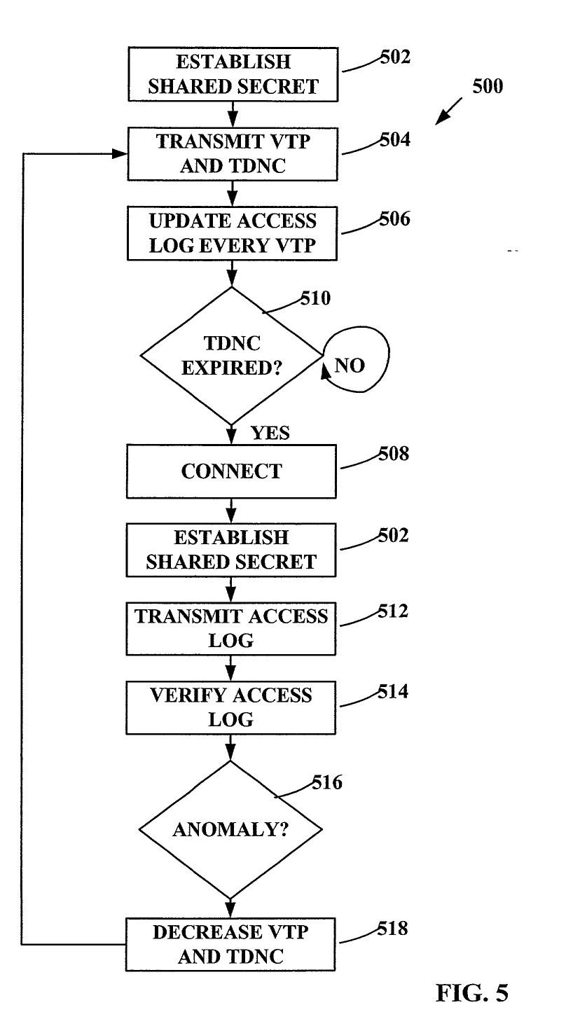

FIG. 5 is a flow chart of an embodiment of the present invention as a method 500 for detecting and deterring rollback attacks. Another aspect of the present invention is a method, such as a method for detecting and deterring rollback attacks 500. A shared secret is established between a client and a server 502. The present invention uses standard cryptographic techniques to establish the shared secret and using that shared secret to securely transmit data. The server transmits a variable time period (VTP) and a time duration to a next connection (TDNC) to the client 504. The client updates an access log approximately every variable time period (VTP) 506. The client initiates a connection 508 to the server, approximately after the time duration to the next connection (TDNC) 510. The client transmits the access log to the server 512. The server verifies the access log 514.

In one embodiment, a new shared secret is established between the client and the server each time the client connects to the server 502. In another embodiment, a new variable time period (VTP) and a new time duration to a next connection (TDNC) are established each time the client connects to the server 504. In another embodiment, the client increments a counter, after each update to the access log. In another embodiment, anomalies are detected automatically 516. In another embodiment, the variable time period (VTP) is decreased, upon detecting an anomaly 518. In another embodiment, the time duration to a next connection (TDNC) is decreased, upon detecting an anomaly 518. In another embodiment, the access log is encrypted. In another embodiment, each entry in the access log is encrypted. In another embodiment, the access log is re-created, each time the client connects to the server. These cryptographic measures prevent an attacker from erasing or deleting entries in the access log.

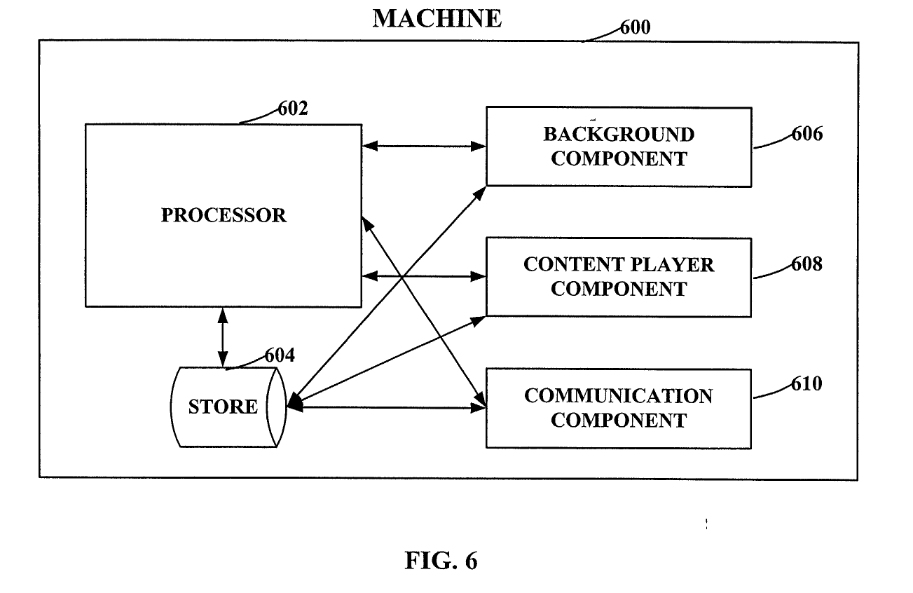

FIG. 6 is a block diagram of an embodiment of the present invention as a machine 600 for detecting and deterring rollback attacks. Another aspect of the present invention is a machine, such as a machine for detecting and deterring rollback attacks 600. The machine 600 comprises a processor 602, a storage device 604 coupled to the processor 602, a background component 606, and a content player component 608. The background component 606 and the content player component 608 are storable on the storage device 604 and executable on the processor 602. The background component 606 updates an access log approximately every variable time period (VTP). The content player component 608 updates the access log to indicate content provided.

In one embodiment, the background component 606 is capable of encrypting the access log. For example, the background component encrypts using a one-way hash of data or a digital signature. In another embodiment, the background component 606 is capable of encrypting each update to the access log. In another embodiment, the machine 600 further comprises a communication component 610 capable of connecting to a server approximately after a time duration to a next connection (TDNC). In another embodiment, the communication component 610 is capable of transmitting the access log. In another embodiment, the communication component 610 is capable of receiving a new variable time period (VTP) and a new time duration to the next connection (TDNC). In another embodiment, the communication component 610 is capable of receiving a new access log. In another embodiment, the background component 606 is capable of decrypting the new access log.

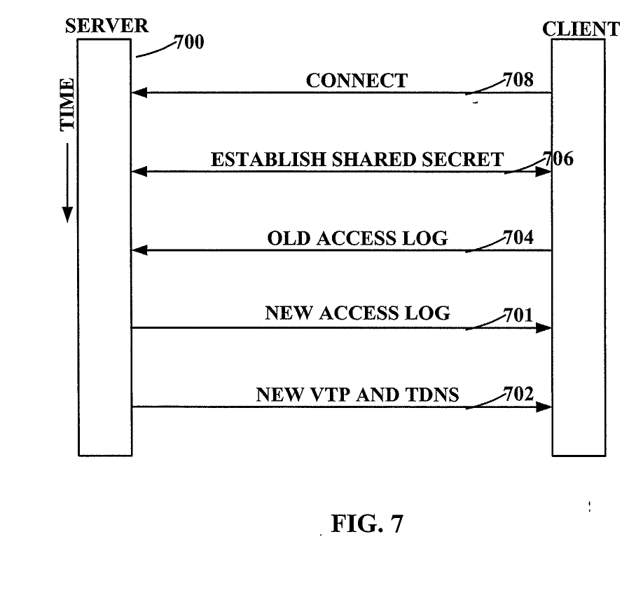

FIG. 7 is a block diagram of client-server communication for an embodiment of the present invention as a method for detecting and deterring rollback attacks. Another aspect of the present invention is a machine-accessible medium having associated content capable of directing the machine to perform a method, such as a method of detecting and deterring rollback attacks. A server 700 transmits a new access log 701, a new variable time period (VTP), and a new time duration to the next connection (TDNC) 702.

In one embodiment, the server receives an old access log 704 and inspects it. In another embodiment, the server establishes a shared secret 706 with a client, decrypts the access log, and encrypts the new access log, the new variable time period (VTP), and the new time duration to the next connection (TDNC).

In another embodiment, the client initiates a connection 708 with the server and transmits the access log to the server. The client receives and stores the new access log, the new variable time period (VTP), and the new time duration to the next connection (TDNC).

In another embodiment, the client establishes a shared secret 706 with the server. The client encrypts the access log, decrypts the new access log, the new variable time period (VTP), and the new time duration to the next connection (TDNC). In another embodiment, the client updates the new access log approximately every new variable time period (VTP).

Suppose a client box is in a consumer's home and connects to a remote server over a modem phone call. The server sends down a key that is used to unlock encrypted moves stored on the client's box and, at the same time, any billing information from the previous billing cycle is transmitted back up to the server. In addition, during that connection, the server computes random numbers for the variable time period (VTP) and the time duration to a next connection (TDNC), such as random numbers for each client or for each class of client. These numbers are computed on the server, stored on the server and transmitted back down to the client along with the keys.

Suppose the server became suspicious that the client was cheating the system in some way and set the time duration to a next connection (TDNC) very small to force the client box to dial in fairly frequently in order to get his keys. Suppose the server had a different customer that seemed to have legitimate usage patterns and set the variable time period (VTP) and the time duration to a next connection (TDNC) to longer values to reduce the workload on the server. The variable time period (VTP) and the time duration to a next connection (TDNC) for each client are used to validate entries in each client's access log. After a connection occurs and new values are transmitted down to the software running on the client box, another piece of software running on the client box runs once a minute or so and checks the clock to see how much time had elapsed. Once the variable time period (VTP) of say 1.5 hours had elapsed, the background software adds an entry to the access log including the time entered. The access log is written to flash or a hard drive or wherever it was stored and then the background process goes back into background mode checking the time once a minute or however frequently. Then, 1.5 hours later, the background process adds another entry.

In parallel, regular primary playback software adds entries whenever the user actually watches a movie. Suppose the user sits down and decides to watch a movie, picks one, and hits play. At that point, the playback software adds an entry to the access log listing an identifier for the movie and a time stamp. The access log on the client box is a file with regular repeated entries at the directed interval and with entries whenever the consumer actually watched the movies. As the background process is making entries, it compares the number of entries in the access log to the time duration to the next connection (TDNC) that was last transmitted. Once the count of entries equals or exceeds the time duration to the next connection (TDNC), the client re-establishes a connection with the server, transmits the access log, downloads key files, and receives the new variable time period (VTP) and the new time duration to a next connection (TDNC). Each time the client connects to the server it is possible for the server to vary the variable time period (VTP) and the time duration to a next connection (TDNC).

The server checks all the data to make sure it complies with the timing requirements. The server receives the access log and validates a signature of the access log file and validates that there are a correct number of entries. It is valid, so the server generates billing information to charge the client's credit card. The server resets the access log or generates a new access log and sends it back down to the client.

On the other hand, suppose the client is actively trying to remove movie entries from the access log. Suppose the client saves the old access log, and rolls back the access log to the previous version so that the number of entries in the access log for the variable time period (VTP) actually decreases. He does this frequently enough so that the number of entries in the access log never hits the threshold for reconnecting to the server. So, the client never gets new keys. Eventually, the client runs out of keys on the client box and is no longer able to watch new movies. Suppose the time duration to a next connection (TDNC) is 3 days and the variable time period is 1 hour, but the client did not call back for 4 or 5 days. The server identifies the anomaly because there is only 3 days worth of entries but it took 4 or 5 days for the client to call in. Thus, the server flags the client as a potentially bad user. The present invention makes it difficult to mount a rollback attack and it detects and deters rollback attacks and other suspicious activity. Also, the server can react once any anomaly is detected, by disabling the client account, for example.

Suppose each time the client box dials in and establishes a modem connection, a new shared secret is established between the client and server as part of that connection. Some random numbers are injected into the messages so that the shared secret is different each time. Once the shared secret is in place, the client encrypts an old access log file based on the movies watched from the last billing cycle. He encrypts the old access log file with the shared secret, transmits it over an open protocol, such as the Internet. The server receives the message and decrypts it with the shared secret to get the old access log file. The server verifies the old access log file and then uses the shared secret to encrypt a new access log file and sends it down to the client along with a new variable time period (VTP) and a new time duration to the next connection (TDNC), which are also encrypted. The client receives them and decrypts them and stores them locally on the client box in a secure manner.

It is to be understood that the above description it is intended to be illustrative, and not restrictive. Many other embodiments are possible and some will be apparent to those skilled in the art, upon reviewing the above description. For example other embodiments include satellite boxes, digital rights management, and more. Therefore, the spirit and scope of the appended claims should not be limited to the above description. The scope of the invention should be determined with reference to the appended claims, along with the full scope of equivalents to which such claims are entitled.

What is claimed is:

1. A system for detecting and deterring rollback attacks, comprising:
a variable time period (VTP);
a time duration to a next connection (TDNC);
an access log;
a server to transmit the variable time period (VTP) and the time duration to the next connection (TDNC) and to verify the access log; and
a client to update the access log approximately every variable time period (VTP) and to connect to the server approximately after the time duration to the next connection (TDNC).

2. The system as recited in claim 1, wherein the client is a personal computer (PC).

3. The system as recited in claim 1, wherein the client is a set-top box.

4. The system as recited in claim 1, wherein the server is a video home server.

5. The system as recited in claim 1, wherein the server is a pay-per-view video server.

6. The system as recited in claim 1, wherein the server is a video-on-demand server.

7. The system as recited in claim 1, wherein the server is a media content provider.

8. The system as recited in claim 1, wherein the next connection is a Secure Authenticated Channel (SAC).

9. The system as recited in claim 1, wherein the access log is used for billing.

10. A method for detecting and deterring rollback attacks, comprising:
establishing a shared secret between a client and a server;
transmitting, by the server to the client, a variable time period (VTP) and a time duration to a next connection (TDNC);
updating, by the client, an access log approximately every variable time period (VTP);
initiating, by the client to the server, a connection approximately after the time duration to the next connection (TDNC);
transmitting, by the client to the server, the access log; and
verifying, by the server, the access log.

11. The method as recited in claim 10, further comprising:
establishing a new shared secret between the client and the server each time the client connects to the server.

12. The method as recited in claim 10, further comprising:
establishing a new variable time period (VTP) and a new time duration to a next connection (TDNC) each time the client connects to the server.

13. The method as recited in claim 10, further comprising:
incrementing, by the client, a counter, after each update to the access log.

14. The method as recited in claim 10, further comprising:
automatically detecting an anomaly.

15. The method as recited in claim 14, further comprising:
decreasing the variable time period (VTP), upon detecting an anomaly.

16. The method as recited in claim 14, further comprising:
decreasing the time duration to a next connection (TDNC), upon detecting an anomaly.

17. The method as recited in claim 10, further comprising:
encrypting the access log.

18. The method as recited in claim 10, wherein each entry in the access log is encrypted.

19. The method as recited in claim 10, wherein the access log is re-created, each time the client connects to the server.

20. A machine for detecting and deterring rollback attacks, comprising:
a processor;
a storage device coupled to the processor;
a background component storable on the storage device and executable on the processor to update an access log approximately every variable time period (VTP); and
a content player component storable on the storage device and executable on the processor to update the access log to indicate content provided.

21. The machine recited in claim 20, wherein the background component is capable of encrypting the access log.

22. The machine recited in claim 20, wherein the background component is capable of encrypting each update to the access log.

23. The machine recited in claim 20, further comprising:
a communication component capable of connecting to a server approximately after a time duration to a next connection (TDNC).

24. The machine recited in claim 23, wherein the communication component is capable of transmitting the access log.

25. The machine recited in claim 23, wherein the communication component is capable of receiving a new variable time period (VTP) and a new time duration to the next connection (TDNC).

26. The machine recited in claim 20, wherein the communication component is capable of receiving a new access log.

27. The machine recited in claim 26, wherein the background component is capable of decrypting the new access log.

28. A machine-accessible medium having associated content capable of directing the machine to perform a method of detecting and deterring rollback attacks, the method comprising:
transmitting, by a server, a new access log; and
transmitting, by the server, a new variable time period (VTP) and a new time duration to the next connection (TDNC).

29. The machine-accessible medium as recited in claim 28, wherein the method further comprises:
receiving, by the server, an old access log; and
inspecting, by the server, the old access log.

30. The machine-accessible medium as recited in claim 28, wherein the method further comprises:
establishing, by the server, a shared secret with a client;
decrypting, by the server, the access log;
encrypting, by the server, the new access log; and
encrypting, by the server, the new variable time period (VTP) and the new time duration to the next connection (TDNC).

31. The machine-accessible medium as recited in claim 28, wherein the method further comprises:
initiating, by a client, a connection with the server;
transmitting, by the client, the access log to the server;
receiving, by the client, the new access log;
receiving, by the client, the new variable time period (VTP) and the new time duration to the next connection (TDNC); and
storing, by the client, the new access log, the new variable time period (VTP), and the new time duration to the next connection (TDNC).

32. The machine-accessible medium as recited in claim 28, wherein the method further comprises:
establishing, by a client, a shared secret with the server;
encrypting, by the client, the access log;
decrypting, by the client, the new access log; and
decrypting, by the client, the new variable time period (VTP) and the new time duration to the next connection (TDNC).

33. The machine-accessible medium as recited in claim 28, wherein the method further comprises:
updating, by a client, the new access log approximately every new variable time period (VTP).
